(19) United States
(12) Patent Application Publication
(10) Pub. No.: US 2006/0048786 A1
(43) Pub. Date: Mar. 9, 2006

(54) Hygienic oral bib

(76) Inventor: Leroy Butler, Detroit, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/204,809

(22) Filed: Aug. 16, 2005

Related U.S. Application Data
(60) Provisional application No. 60/602,101, filed on Aug. 17, 2004.

(51) Int. Cl. A61C 5/14

(52) U.S. Cl. 128/860

(57) ABSTRACT

An oral bib includes a thin sheet protective shield portion having resistance to the passage of a sexually transmitted disease microbe therethrough. The shield portion is configured to overlie a chin and mouth region of a wearer and has opposing sides. A strap is adapted to secure said shield portion to a wearer head.

### RELATED APPLICATIONS

This application is a non-provisional application claiming priority of U.S. provisional application 60/602,101 filed Aug. 17, 2004, the contents of which are hereby incorporated by reference.

### FIELD OF THE INVENTION

The present invention in general relates to a barrier against sexually transmitted diseases and in particular to a face-mounted barrier.

### BACKGROUND OF THE INVENTION

While condoms have gained general acceptance for their effectiveness in preventing the spread of sexually transmitted diseases (STDs) during intercourse, the dental dam has generally met with limited acceptance. The dental dam, originally developed as an adjunct to dental procedures, has been adapted as a barrier against the spread of STDs during oral sex. The dental dam has a thin sheet of latex which serves as a barrier between partners when placed intermediate therebetween. However, oral dams tend to become displaced from the recipient partner's anal or vaginal area during usage. Thus, there exists a need for an oral protective device against sexually transmitted diseases that is not readily displaced from between sexual partners.

### SUMMARY OF THE INVENTION

An oral bib includes a thin sheet protective shield portion having resistance to the passage of a sexually transmitted disease microbe therethrough. The shield portion is configured to overlie a chin and mouth region of a wearer and has opposing sides. A strap is adapted to secure said shield portion to a wearer head.

### BRIEF DESCRIPTION OF THE DRAWINGS

The present invention is further illustrated with respect to the following exemplary and non-limiting embodiments depicted in the accompanying drawings.

FIG. 1 is a perspective view of an inventive hygienic oral bib;

FIG. 2 is a frontal view of the inventive bib depicted in FIG. 1;

FIGS. 3A-3F represent alternate textural embodiments of blade portions of an inventive bib;

FIGS. 4A-4F are perspective views of inventive embodiments having alternate strap configurations; and

FIG. 5 is a perspective view of an inventive embodiment having ear loops.

### DETAILED DESCRIPTION OF THE INVENTION

The present invention has utility as a device for the prevention of STDs that otherwise are transmitted by oral sex. A thin elastomeric sheeting material that is resistant to transmission therethrough of microbes is fashioned to secure around the chin and mouth of a user and retained in this position with a securement encompassing the ears or head of the user.

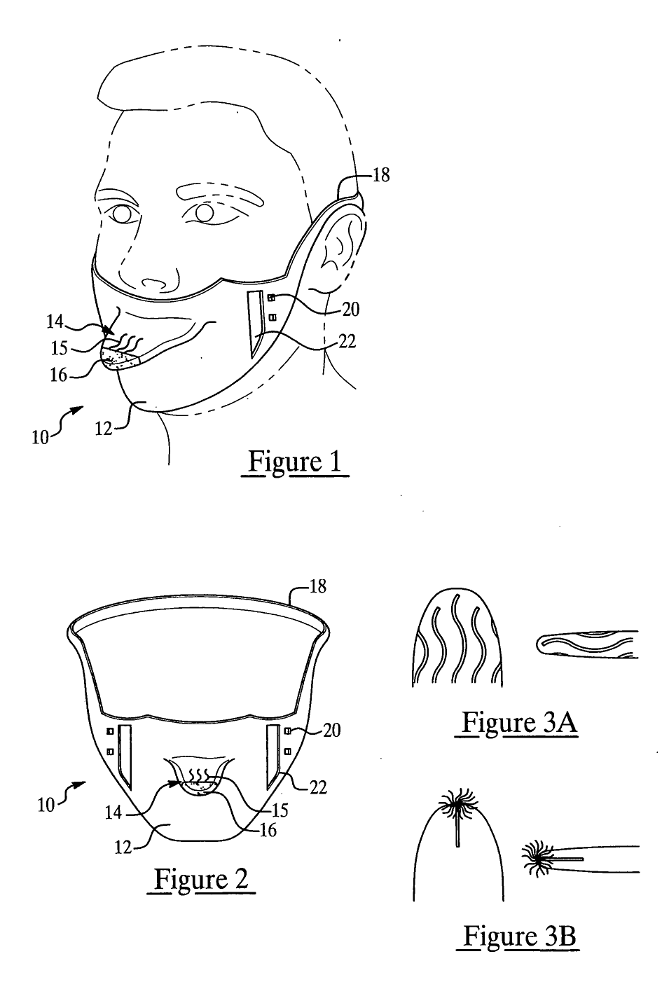

Referring now to FIGS. 1 and 2, an inventive bib is shown generally at 10. The bib 10 has a shield portion 12 encompassing the chin and mouth region of a user. Preferably, the shield portion 12 includes a tongue sheath portion 14 positioned upon placement over a wearer's face so as to overlie a user mouth. The shield portion 12 is constructed of an elastomeric sheet material resistant to the passage of STD causing organisms therethrough. As such, the shield material is preferably pore free or, if pores are present, such pores are less than about 0.2 microns. Shield portion materials illustratively include latex rubber, silicone rubber, polyalkylenes, and other materials conventional for the production of synthetic polymer condoms.

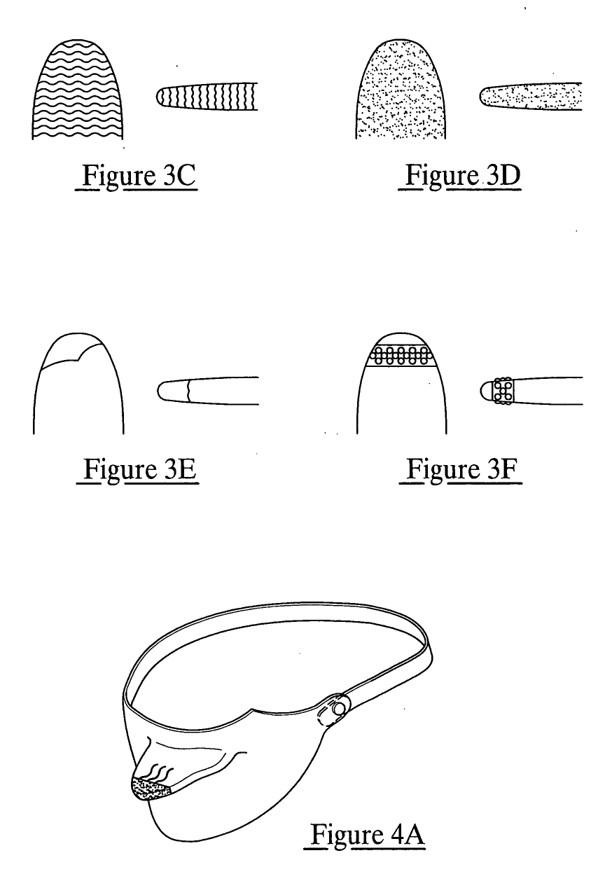

A tongue portion 14 is appreciated to be formed from a continuous sheet of material making up the shield portion or alternatively to be formed from a separate piece of material with the proviso that a hermetic seal is formed at the interface between tongue portion and shield portion. The tongue portion 14 is readily formed of the same materials as the shield portion 12, yet dissimilar materials for the tongue portion 14 and shield portion 12 are recognized to be operative herein. Methods of forming a hermetic seal between the shield and tongue portions illustratively include thermal welding, sonic welding, and contact adhesives. Optionally, the tongue portion 14 has contours 15. An illustrative group of such contours is depicted in FIGS. 3A-3F and include longitudinal waves, pilli, transverse waves, dimples, a step, and a textured region overlying a sealed chamber.

Optionally, a terminal area of the tongue portion 14 includes a sealed chamber 16. The sealed chamber containing air, a liquid, or as depicted in FIG. 3F, a self-contained miniature battery-powered flashlight or vibrator circuit.

The shield portion 12 is attached to a strap 18. The strap 18 is suited to encompass the back of a wearer head and tension the inventive bib 10 against a user face while the shield portion 12 surrounding a user chin prevents inadvertent bib dislocation during usage. It is appreciated that an inventive bib 10 including the strap 18 is readily formed from a unitary material. Alternatively, a strap 18 is formed of a different material or greater thickness of material relative to the shield portion. Conventional joinders for adhering a strap to a thin shield portion illustratively include contact adhesives, thermal welding, sonic welding, and stitches.

Optionally, a hole 20 or cutout 22 is placed in the shield portion so as to overlie a wearer cheek and afford greater comfort without sacrificing the protective aspects of an inventive bib.

It is appreciated that an inventive bib is suitable for modification with conventional additives illustratively including pigments or dyes, antimicrobial compounds, fragrances, plasticizers and the like. Additionally, an inventive bib is amenable to dusting with conventional anti-stick powders such as talc, cornstarch and the like.

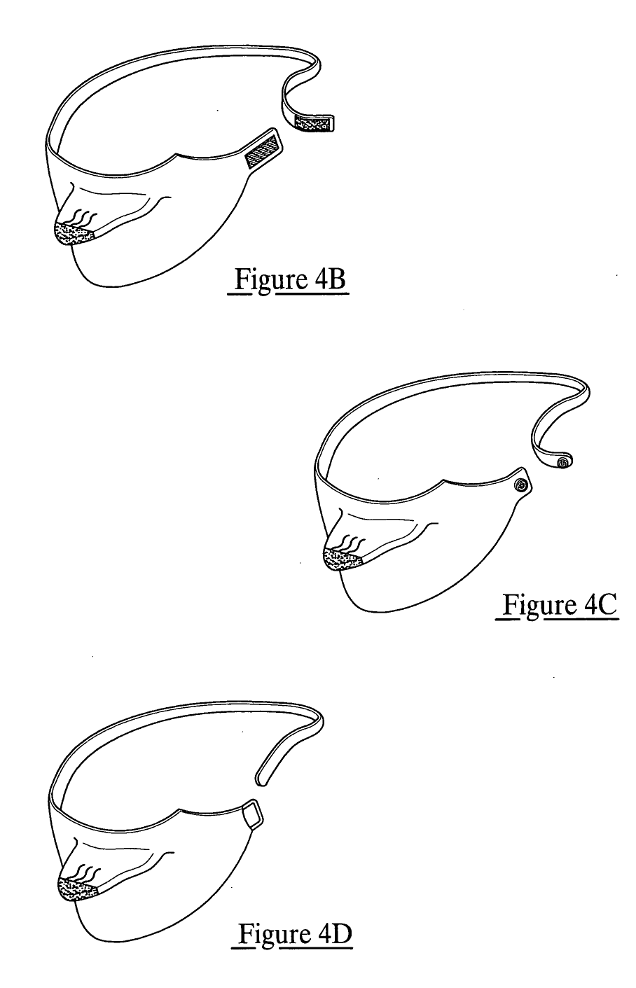

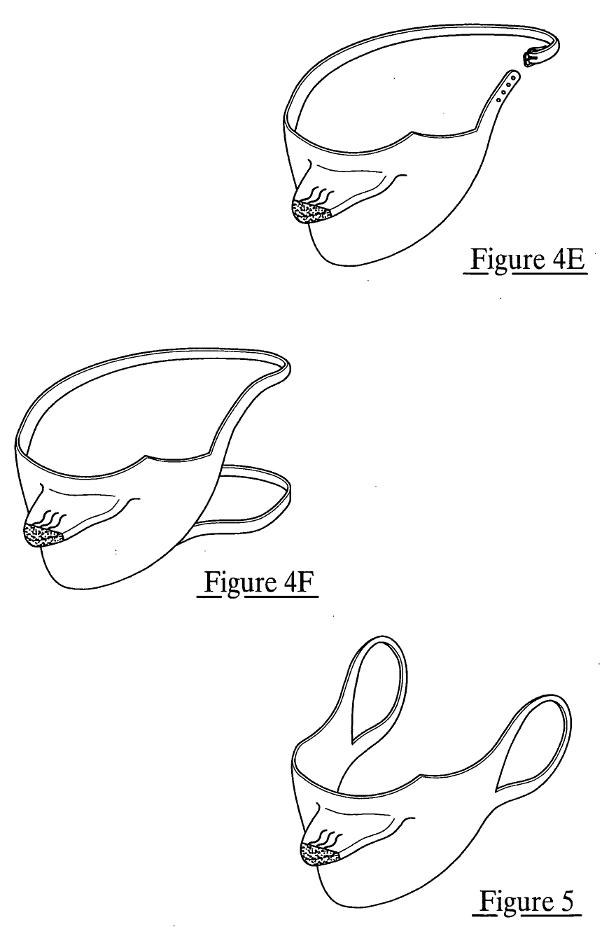

FIGS. 4A-4F illustrate alternate strap configurations operative with an inventive bib. The strap configuration depicted in FIG. 5 is adapted to encompass the ears of a wearer such that contact with a user chin and the two ear straps forms a three-point retention system.

The present invention is amenable to various modifications by one of ordinary skill in the art to which the invention pertains. These modifications nonetheless retain the spirit of the present invention. These modifications and equivalents thereof are intended to be encompassed within the scope of the appended claims.

1. An oral bib comprising:
a thin sheet protective shield portion having resistance to the passage of a sexually transmitted disease microbe therethrough, said shield portion configured to overlie a chin and mouth region of a wearer and having opposing sides; and
a strap adapted to secure said shield portion to a wearer head.

2. The bib of claim 1 wherein said protective shield portion is formed of an elastomeric material.

3. The bib of claim 1 wherein said protective shield portion is formed of a latex rubber.

4. The bib of claim 1 further comprising a tongue portion extending from said protective shield portion and overlying the wearer mouth region.

5. The bib of claim 4 wherein said tongue portion and said protective shield portion are unitary.

6. The bib of claim 4 wherein said tongue portion is distinct from said protective shield portion with a hermetic seal therebetween.

7. The bib of claim 4 wherein said tongue portion further comprises a sealed chamber.

8. The bib of claim 7 wherein said chamber includes therein an item selected from the group consisting of: air, a liquid, a flashlight circuit, and a vibrator circuit.

9. The bib of claim 4 wherein said tongue portion has a contour thereon.

10. The bib of claim 9 wherein said contour is one selected from the group consisting of longitudinal waves, pilli, transverse waves, dimples, a step, and a raised textured region.

11. The bib of claim 1 wherein said strap comprises two loops each extending from one of the opposing sides and adapted to encompass a user ear.

12. The bib of claim 1 wherein the shield portion has a ventilation aperture therethrough.
